(19) United States
(12) Patent Application Publication
(10) Pub. No.: US 2025/0139430 A1
(43) Pub. Date: May 1, 2025

(54) SMART METHOD FOR PREDICTING CHOKE HEALTHFULNESS AND LIFETIME FOR GAS WELL

(71) Applicant: SAUDI ARABIAN OIL COMPANY, Dhahran (SA)

(72) Inventors: Rima Taqi ALFARAJ, Dhahran (SA); Banowo DWIYONOLOKA, Dhahran (SA); Mohammed ALALI, Dhahran (SA); Mohamed FATANI, Dhahran (SA); Waleed ISAWI, Dhahran (SA)

(73) Assignee: SAUDI ARABIAN OIL COMPANY, Dhahran (SA)

(21) Appl. No.: 18/499,003

(22) Filed: Oct. 31, 2023

(51) Int. Cl. G06N 3/08

(52) U.S. Cl. CPC G06N 3/08

(57) ABSTRACT

A method for forecasting the lifetime of a choke includes determining choke opening baseline using a machine learning (ML) model, determining a realtime choke opening curve, comparing the choke opening baseline to the realtime choke opening curve, and providing an assessment of choke lifetime as a function of said comparing.

### FIELD OF THE DISCLOSURE

The present disclosure relates generally to choke valves used in oil and gas applications, and more particularly, to methods for assessing the healthfulness of choke valves used in such applications.

### BACKGROUND OF THE DISCLOSURE

During the production phase of hydrocarbon recovery in the oil and gas industry, high pressure fluids (e.g., hydrocarbon gases and liquids) are produced to the well surface for capture and processing. Wellbores are commonly capped with a wellhead (alternately referred to as a “Christmas” tree), which helps to regulate the flow of fluids exiting the wellbore. Various pipelines or conduits extend from the wellhead to convey the extracted fluids downstream, and fluid pressure control within these pipelines is critical.

Pressure control of the fluid is commonly performed using one or more choke valves (i.e., “chokes”) arranged within the pipelines and having one or more selectively controllable orifices in the fluid flow circuit. The chokes may be actuated automatically or manually, or a combination of these, based on sensor measurements of factors such as temperature, flow rate, pressure, and so on, obtained from various points in the fluid circuit.

Proper operation of the chokes is critical, and the ability to forecast the lifetime of the chokes and to repair or replace aging ones ahead of unexpected failure can avoid costly operational disruptions. The baseline of the choke opening as a function of flowrate is theoretically determined by well parameters such as flowing wellhead pressure, temperature, produced gas properties and the coefficient of flow (CV). There are several analytical correlations in the literature that estimate the value particularly on the gas compressibility factor and choke coefficient of flow (CV). However, the available correlations to estimate CV rely on multiple parameters and empirical numbers and assumptions, which often fail to provide satisfactory predictions. It is thus generally unacceptable to rely on these correlations to determine the baseline of the choke opening as a function of flowrate as it causes severe errors in the estimating the actual choke opening. Also, the models available for sub-critical flow are not providing satisfactory accuracy for prediction and are often difficult to use. In addition, there is currently no analytical or empirical prediction for forecasting the choke lifetime based on the aforementioned well parameters.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for forecasting the lifetime of a choke includes determining choke opening baseline using a machine learning (ML) model, determining a realtime choke opening curve, comparing the choke opening baseline to the realtime choke opening curve, and providing an assessment of choke lifetime as a function of said comparing.

In another embodiment, a machine-readable storage medium having stored thereon a computer program for forecasting the lifetime of a choke. The computer program includes a routine of set instructions for causing the machine to perform the steps of determining choke opening baseline using a machine learning (ML) model, determining a realtime choke opening curve, comparing the choke opening baseline to the realtime choke opening curve, and providing an assessment of choke lifetime as a function of said comparing.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a choke valve healthfulness determining system 100 in accordance with certain embodiments.

FIG. 2 is a graph of Spearman's correlation matrix showing the relationship between parameters using sample field data.

FIG. 3 is a flow diagram of an example method for determining a predicted baseline curve of a choke under investigation.

FIG. 4 is a flow diagram of an example method for predicting choke opening as a function of time.

FIG. 5 is a flow diagram of an example method for making a healthfulness assessment commensurate with the life of a choke under investigation and to forecast the lifetime of a choke.

FIG. 6 is a block diagram of a computer system that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to choke valves used in oil and gas applications, and more particularly, to methods for assessing the healthfulness of choke valves used in such applications.

In accordance with certain embodiments, a choke baseline determining system and method for first training a machine learning analytical model to predict the accurate baseline of a choke based on critical input data and verified baseline of specific chokes using machine learning algorithms are disclosed. A second, choke opening determining system and method are disclosed to train a second machine learning analytical model used to predict the choke opening (%) for given flow rate, temperature, and pressures. The choke opening (%) can be compared with the baseline determined in the first procedure, whereby the percentage of difference between the determined curves will determine the choke's life.

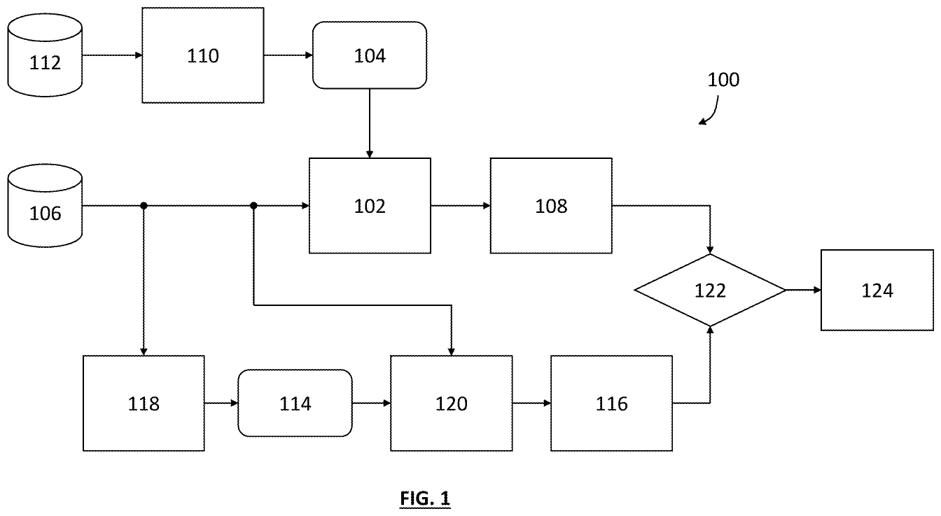

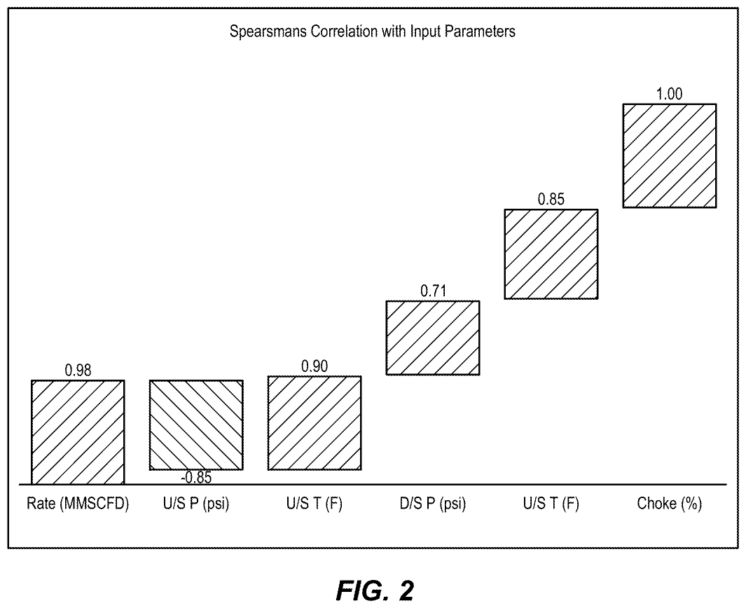

FIG. 1 is a block diagram of a choke valve healthfulness determining system 100 in accordance with certain embodiments. System 100 uses predictor 102 that applies a choke baseline machine learning (ML) model 104 to acquired real-time well dynamic data 106 to accurately predict the baseline of a choke under investigation (not shown). The real-time well dynamic data 106 can include flowrate, choke upstream pressure (U/S) and temperature and choke downstream (D/S) pressure and temperature as input, as well as other measurements relating to the operation of the well under investigation. Such other parameters can relate for instance to completion size/geometry (tubing, depths, tree bore size), produced fluid properties (density, % H2S/CO2) and choke type/size (i.e. maximum choke CV). FIG. 2 is a graph of Spearman's correlation matrix showing the relationship between parameters using sample field data.

The output of the predictor 102 is a predicted baseline curve 108 of the choke under investigation. Determining the choke baseline curve 108 using machine learning in this manner provides a reliable predictive approach without the use of conventional correlations that require multiple assumptions and introduce high complexity and inaccuracy potential.

In certain embodiments, base line machine learning (ML) model 104 can be generated using training algorithms 110 whose input data 112 can comprise specific well completion size/type, produced gas properties and choke type/size from historic data of other well operations and other similar chokes, in similar contexts, etc. and thereby include real-time well dynamic data similar to that mentioned above-that is, flowrate, choke upstream pressure (U/S) and temperature and choke downstream (D/S) pressure and temperature, completion size/geometry (tubing, depths, tree bore size), produced fluid properties (density, % H2S/CO2) and choke type/size (i.e. maximum choke CV). The model is thus trained with real-time data to create a baseline model for all chokes (based on healthy choke data) using the healthy choke data baseline. Any deviation from the baseline is considered a beginning of failure; depending on the % of the deviation, the 100% deviation will represent the failed choke and right before it is where the choke needs replacement.

In certain embodiments, the real-time well dynamic data 106 is also used to train an ML sub-model 114 that is used to predict the choke opening as a function of time to generate a realtime curve 116 that will be compared with the baseline curve 108 determined for the specific choke under investigation to forecast the lifetime of the choke. The training for ML sub-model 114 is performed by training algorithms 118 configured to receive the real-time well dynamic data 106 and to train the second machine learning analytical model 114, which is used by predictor 120 to generate the realtime curve 116. A comparator 122 compares opening percentage (%) for a given rate, temperature, and pressures based on the curves 108 and 116, and depending on the degree of agreement of the compared values, a healthfulness assessment or grade 124 is then issued, indicating the healthfulness, and commensurately the life, of the choke under investigation. Choke lifetime can be determined by comparing the choke's opening % baseline with real-time choke opening %, with the percent difference referred to as the lifetime of the choke.

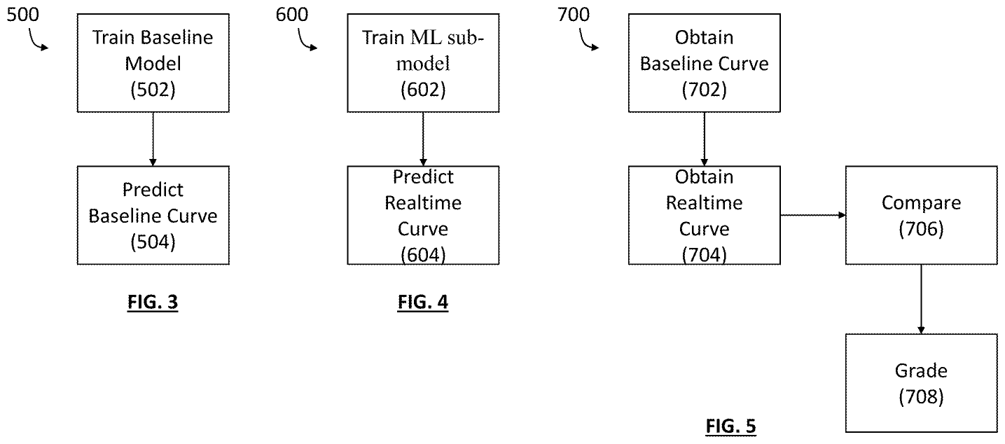

In view of the structural and functional features described above, example methods will be better appreciated with reference to FIGS. 3-5. While, for purposes of simplicity of explanation, the example methods of FIGS. 3-5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 3 is an example of a method 300 for determining a predicted baseline curve of a choke under investigation. At 302, choke baseline machine learning model, such as ML model 104 of FIG. 1, is trained. The training can be performed using a trainer applying suitable ML algorithms such as XGboost, artificial neural networks (ANN), recurrent neural networks, and so on, on data from specific well completion size/type, produced gas properties and choke type/size from historic data of other well operations and other similar chokes, in similar contexts as described above. At 304, choke baseline machine learning model is applied by a predictor, such as predictor 102, to acquired real-time well dynamic data, such as data 106 from FIG. 1, to accurately predict the baseline of the choke under investigation.

FIG. 4 is an example of a method 400 to predict choke opening as a function of time to generate a realtime curve such as curve 116 in FIG. 1. At 402, ML a sub-model such as ML sub-model 114 is trained. The training for the ML sub-model may be conducted by a trainer using algorithms such as algorithms 118 configured to receive real-time well dynamic data such as data 106. At 404, a predictor, such as predictor 120 above, generates a realtime curve such as curve 116.

FIG. 5 is an example of a method 500 to make a healthfulness assessment commensurate with the life a choke under investigation and to forecast the lifetime of a choke. At 502, a baseline curve such as curve 108 above is obtained. At 504, a realtime curve such as curve 116 is obtained. At 506, the baseline and realtime curves are compared. At 508, a grade indicating the agreement value and the lifetime of the choke is issued.

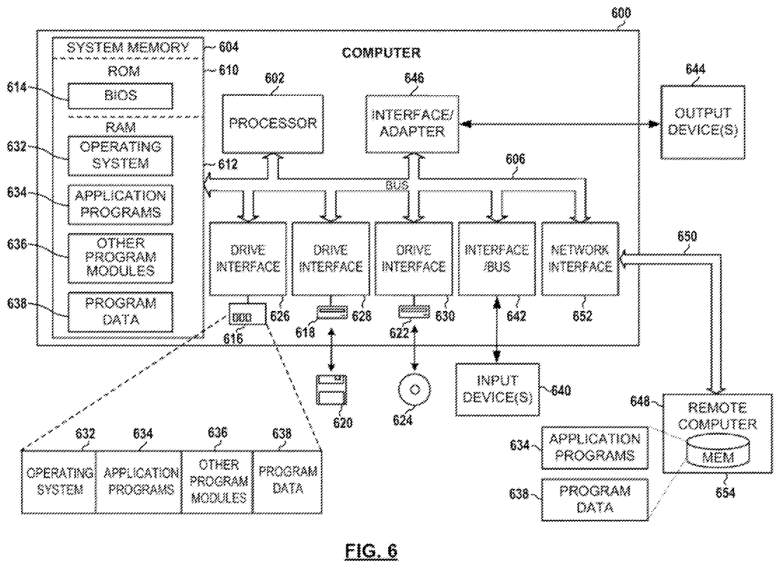

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts of processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard. FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. System memory 604 can include volatile (e.g. RAM. DRAM, SDRAM, Double Data Rate (DDR) RAM, etc.) and non-volatile (e.g. Flash. NAND, etc.) memory. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 610 containing the basic routines that help to transfer information among elements within computer system 600.

Computer system 600 can include a hard disk drive 616, magnetic disk drive 618. e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 610, including operating system 632, one or more application programs 634, other program modules 636, and program data 638. In some examples, the application programs 634 can include predictors 102 and 120, comparator 122, and trainers executing ML algorithms such as algorithms 110 and 118; and the program data 638 can include ML models 104 and 114 and outputs 108, 116 and 124. The application programs 634 and program data 638 can include functions and methods programmed to determine a predicted baseline curve of a choke under investigation; predict choke opening as a function of time to generate a realtime curve; and/or make a healthfulness assessment commensurate with the life a choke under investigation such as shown and described herein.

A user may enter commands and information into computer system 600 through one or more input devices 640, such as a pointing device (e.g., a mouse, touch screen), keyboard, microphone, joystick, game pad, scanner, and the like. These and other input devices 640 are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for forecasting the lifetime of a choke comprising:
determining choke opening baseline using a machine learning (ML) model;
determining a realtime choke opening curve;
comparing the choke opening baseline to the realtime choke opening curve; and
providing an assessment of choke lifetime as a function of said comparing.

2. The method of claim 1, further comprising constructing the machine learning model using training algorithms whose input data includes specific well completion size/type, produced gas properties and choke type/size from historic data.

3. The method of claim 1, wherein determining choke opening baseline comprises applying the ML model to acquired real-time well dynamic data including flowrate, choke upstream pressure (U/S) and temperature and choke downstream (D/S) pressure and temperature as input.

4. The method of claim 1, determining a realtime choke opening curve comprises applying an ML sub-model to acquired real-time well dynamic data including flowrate, choke upstream pressure (U/S) and temperature and choke downstream (D/S) pressure and temperature as input.

5. The method of claim 4, wherein the ML sub-model is constructed by training algorithms configured to receive the real-time well dynamic data.

6. The method of claim 2, wherein the training algorithms are selected from XGboost, artificial neural networks (ANN), recurrent neural networks.

7. The method of claim 5, wherein the training algorithms are selected from XGboost, artificial neural networks (ANN), recurrent neural networks.

8. A machine-readable storage medium having stored thereon a computer program for forecasting the lifetime of a choke, the computer program comprising a routine of set instructions for causing the machine to perform the steps of:
determining choke opening baseline using a machine learning (ML) model;
determining a realtime choke opening curve;
comparing the choke opening baseline to the realtime choke opening curve; and providing an assessment of choke lifetime as a function of said comparing.

9. The machine-readable storage medium of claim 8, the set of instructions further causing the machine to perform the steps of: constructing the machine learning model using training algorithms whose input data includes specific well completion size/type, produced gas properties and choke type/size from historic data.

10. The machine-readable storage medium of claim 8, wherein determining choke opening baseline comprises applying the ML model to acquired real-time well dynamic data including flowrate, choke upstream pressure (U/S) and temperature and choke downstream (D/S) pressure and temperature as input.

11. The machine-readable storage medium of claim 8, wherein determining a realtime choke opening curve comprises applying an ML sub-model to acquired real-time well dynamic data including flowrate, choke upstream pressure (U/S) and temperature and choke downstream (D/S) pressure and temperature as input.

12. The machine-readable storage medium of claim 11, wherein the ML sub-model is constructed by training algorithms configured to receive the real-time well dynamic data.

13. The machine-readable storage medium of claim 9, wherein the training algorithms are selected from XGboost, artificial neural networks (ANN), recurrent neural networks.

14. The machine-readable storage medium of claim 12, wherein the training algorithms are selected from XGboost, artificial neural networks (ANN), recurrent neural networks.
